(19) United States
(12) Patent Application Publication
(10) Pub. No.: US 2018/0117968 A1
(43) Pub. Date: May 3, 2018

(54) BURST-RESISTANT TIRE WITH TUBULAR EMBEDDED OPEN-STRUCTURE

(71) Applicant: SHENZHEN KINGTITAN TECHNOLOGY CO., LTD, Shenzhen (CN)

(72) Inventors: Bing WANG, Shenzhen (CN); Qiansun YU, Shenzhen (CN)

(21) Appl. No.: 15/855,501

(22) Filed: Dec. 27, 2017

Related U.S. Application Data
(63) Continuation of application No. PCT/CN2016/087176, filed on Jun. 25, 2016.

(30) Foreign Application Priority Data
Jul. 3, 2015 (CN) 201510391967.1

(51) Int. Cl. B60C 7/10

(52) U.S. Cl. CPC B60C 7/10; B60C 2007/107

(57) ABSTRACT

The present invention discloses a burst-resistant tire with tubular embedded open-structure, comprising an outer ring and an inner ring. The outer ring is divided into a left outer ring and a right outer ring symmetrically arranged through a radial plane of a tire center. The left outer ring and the inner ring are provided with a left rim ring, a right rim ring is arranged between the right outer ring and the inner ring, and the left rim ring and the right rim ring are connected at the radial plane of the tire center. When touching the ground, a rim forms a buffer structure via left and right parts using a joint point between the rim and the outer ring as a center, thereby rapidly dispersing stress, avoiding force concentrating on a single point, causing overloading.

### TECHNICAL FIELD

The present invention relates to the field of non-pneumatic tires, and more specifically to a burst-resistant tire with tubular embedded open-structure.

### BACKGROUND OF THE INVENTION

Tyre is the generic term for tires, and is usually made of a wear-resistant rubber material, with a solid tire and an pneumatic tire. The pneumatic tire is composed of an inner tire and an outer tire, and the defect of the pneumatic tire is that the rubber material of the tire tread is easy to wear, and it is likely to have the inner tire burst because of the inflatable support. However, a plurality of defects exist in the solid tire in the prior art, such as which material is used to make solid tires. Later studies found that polyurethane materials have very good advantages for making tires, such as wear resistance and hardness adjustment.

Patent No. 200710108803.9 discloses a non-pneumatic vehicle tire, the tire is provided with a series of tread supporting rings of transversely-extending circular tubular channel and a series of inner rings of transversely-extending rim joint structure, so that the cost and the weight are reduced, and on the other hand, the comfort of the tire is improved. However, the structure is also problematic, since the tread supporting rings run through the whole placenta, when the diameter of the supporting rings is large, due to the fact that the span of the supporting rings is large and the supporting force of the tread between two adjacent supporting rings is small, it is easy to cause the uneven stress on the whole tread.

### SUMMARY OF THE INVENTION

The present invention aims to overcome the defects in the prior art, and provides a uniform stress, burst-resistant and tubular embedded open-structure tire.

The technical scheme of the present invention is as follows: a burst-resistant tire with tubular embedded open-structure, comprising an outer ring and an inner ring; the outer ring is divided into a left outer ring and a right outer ring symmetrically arranged through a radial plane of a tire center, wherein the left outer ring and the inner ring are provided with a left rim ring; a right rim ring is arranged between the right outer ring and the inner ring, and the left rim ring and the right rim ring are connected at the radial plane of the tire center.

The left rim ring comprises a rim evenly distributed around an axis of the inner ring and two adjacent rims are mutually connected to form a closed loop, and the rim is in contact with the left outer ring and the inner ring; the right rim ring comprises a rim evenly distributed around an axis of the inner ring and two adjacent rims are mutually connected to form a closed loop, and the rim is in contact with the right outer ring and the inner ring.

The rim is parallel to the axis of the inner ring and is a tubular structure with a circular, an oval or a polygonal shape.

The left rim ring and the right rim ring are asymmetrically arranged, and an intersection position of the two adjacent rims in the left rim ring corresponds to or does not correspond to a circle center of the rim of the right rim ring.

The left rim ring and the right rim ring are symmetrically arranged, and a tubular structure of the left rim ring and the tubular structure of the right rim ring are longitudinally penetrated.

The radial cross section of the tire with tubular embedded open-structure is a trapezoid structure with equal size of the inner ring and the outer ring or larger outer ring and smaller inner ring.

The beneficial effects of the present invention are as follows: the present invention provides a burst-resistant tire with tubular embedded open-structure and is provided with a left rim ring and a right rim ring, and both the left rim ring and the right rim ring are in contact with the inner ring and the right rim ring. When touching the ground, a rim forms a buffer structure via left and right parts using a joint point between the rim and the outer ring as a center by contact with the outer ring, thereby rapidly dispersing stress, and avoiding force concentrating on a single point, causing overloading.

### BRIEF DESCRIPTION OF THE DRAWINGS

FIG. 1 is a front view of the tire of the left rim ring and the right rim ring according to an embodiment of the present invention;

FIG. 2 is a structural diagram of the rim inside the tire according to an embodiment of the present invention.

In the figures, 1 is the inner ring, 2 is the outer ring and 3 is the rim.

### DETAILED DESCRIPTION OF THE INVENTION

The technical scheme in the embodiments of the present invention will be described clearly and completely hereinafter with reference to the accompanying drawings in the embodiments of the present invention. Apparently, the described embodiments are merely some but not all embodiments of the present invention. All other embodiments obtained by those ordinary skill in the art based on the embodiments of the present invention without creative efforts shall fall within the protection scope of the present invention.

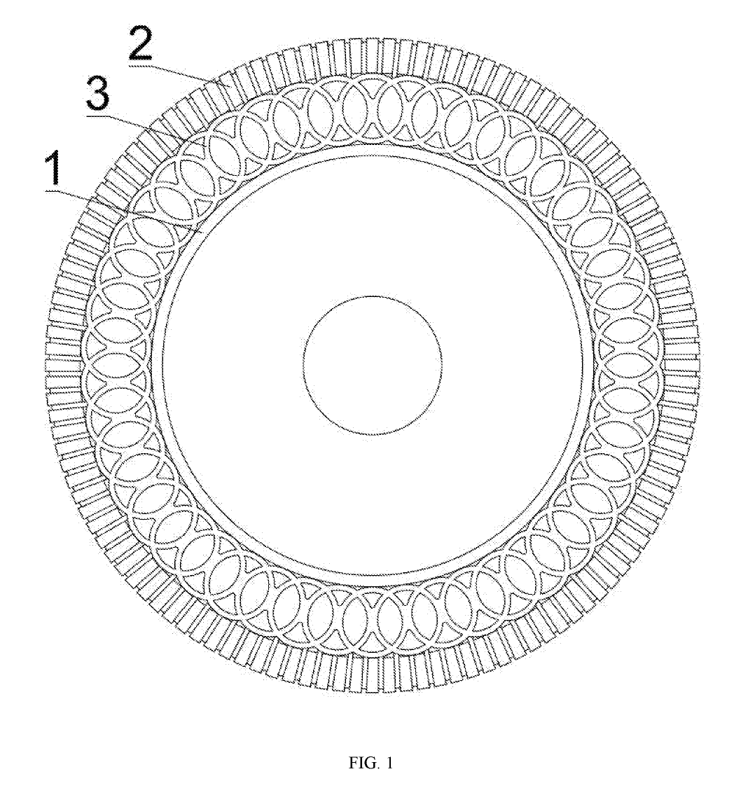

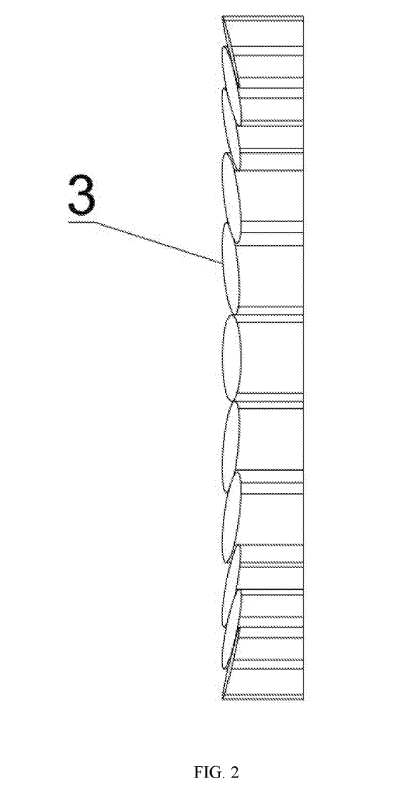

As shown in FIG. 1 and FIG. 2, a burst-resistant tire with tubular embedded open-structure is composed of an outer ring 2, an inner ring 1, a left rim ring and a right rim ring, the left rim ring and the right rim ring are connected with the outer ring 2 and the inner ring 1; the left rim ring and the right rim ring are also fixedly connected, the left rim ring and the right rim ring are symmetrically or asymmetrically arranged by taking the radial plane of the tire center as a boundary line, and the left rim ring and the right rim ring are respectively composed of a rim which is evenly distributed around the axis of the inner ring and forms a closed loop; when symmetrically arranged, the tubular structure of the left rim ring and the tubular structure of the right rim ring are longitudinally penetrated; when the left rim ring and the right rim ring are asymmetrically arranged, the left rim ring and the right rim ring can be partially staggered or positively staggered, and the positively staggered refers to that the intersection position between the two rims in the left rim ring correspond to the circle center of the rim of the right rim ring, and compared with symmetrical arrangement and partially staggered arrangement, the structure can obtain the optimal buffering performance when the tire is in contact with the ground. Because the left rim ring and the right rim ring are evenly distributed, the connecting lines between the two rims in the left rim ring leads to a vertical plane perpendicular to the outer ring 2, the intersection of the vertical plane and the outer ring 2 does not have a supporting point, and the extension line of the intersection line of the vertical plane and the outer ring 2 is just overlapped with the connection line of the rim in the right rim ring and the outer ring 2, so that uniform supporting of each point of the outer ring 2 of the wheel rim 3 on the tire structure is guaranteed to ensure even force of the whole tire structure and improve comfort.

A radial cross section of the tire with tubular embedded open-structure is a trapezoid structure with equal size of the inner ring and the outer ring or larger outer ring 2 and smaller inner ring 1, the trapezoid structure is a state which is inclined towards the inside of the tire axis from the outer ring 2 to the inner ring 1, and the tubular structure of the rim 3 is also obliquely arranged corresponding to the trapezoidal structure.

What is claimed is:

1. A burst-resistant tire with tubular embedded open-structure, comprising an outer ring and an inner ring; the outer ring is divided into a left outer ring and a right outer ring symmetrically arranged through a radial plane of a tire center, wherein the left outer ring and the inner ring are provided with a left rim ring, a right rim ring is arranged between the right outer ring and the inner ring, and the left rim ring and the right rim ring are connected at the radial plane of the tire center.

2. The tire with tubular embedded open-structure according to claim 1, wherein the left rim ring comprises a rim evenly distributed around an axis of the inner ring and two adjacent rims are mutually connected to form a closed loop, and the rim is in contact with the left outer ring and the inner ring; the right rim ring comprises a rim evenly distributed around an axis of the inner ring and two adjacent rims are mutually connected to form a closed loop, and the rim is in contact with the right outer ring and the inner ring.

3. The tire with tubular embedded open-structure according to claim 2, wherein the rim is parallel to the axis of the inner ring and is a tubular structure with a circular, an oval or a polygonal shape.

4. The tire with tubular embedded open-structure according to claim 3, wherein the left rim ring and the right rim ring are asymmetrically arranged, and an intersection position of the two adjacent rims in the left rim ring corresponds to or does not correspond to a circle center of the rim of the right rim ring.

5. The tire with tubular embedded open-structure according to claim 3, wherein the radial cross section of the tire with tubular embedded open-structure is a trapezoid structure with equal size of the inner ring and the outer ring or larger outer ring and smaller inner ring.

6. The tire with tubular embedded open-structure according to claim 4, wherein the radial cross section of the tire with tubular embedded open-structure is a trapezoid structure with equal size of the inner ring and the outer ring or larger outer ring and smaller inner ring.

7. The tire with tubular embedded open-structure according to claim 5, wherein the radial cross section of the tire with tubular embedded open-structure is a trapezoid structure with equal size of the inner ring and the outer ring or larger outer ring and smaller inner ring.
